(19) United States
(12) Patent Application Publication
(10) Pub. No.: US 2015/0252501 A1
(43) Pub. Date: Sep. 10, 2015

(54) ADVANCED OXIDATION METHOD FOR PRODUCING HIGH-DENSITY OXIDIZED POLYACRYLONITRILE FIBERS

(71) Applicant: UT-BATTELLE, LLC, Oak Ridge, TN (US)

(72) Inventors: Felix Leonard Paulauskas, Knoxville, TN (US); Amit Kumar Naskar, Knoxville, TN (US); Truman Andrew Bonds, Knoxville, TN (US)

(73) Assignee: UT-BATTELLE, LLC, Oak Ridge, TN (US)

(21) Appl. No.: 14/715,831

(22) Filed: May 19, 2015

Related U.S. Application Data
(62) Division of application No. 13/163,134, filed on Jun. 17, 2011.

(51) Int. Cl. D03D 15/12; D06M 10/02; D01F 6/18; D01F 6/38; C08F 122/30; D06M 10/08

(52) U.S. Cl. CPC D03D 15/12; C08F 122/30; D06M 10/08; D01F 6/18; D01F 6/38; D06M 10/02; D06M 2101/28

(57) ABSTRACT

Method for producing an oxidized PAN fiber (OPF) wherein a PAN fiber is subjected to an oxidation process in which reactive oxidizing species are maintained in close enough proximity to the PAN fiber during the oxidation process such that a core of the PAN fiber is converted to a crosslinked thermoset morphology before an oxidized shell of the PAN fiber becomes thick enough to substantially inhibit penetration of the reactive oxidizing species into the core. The resulting OPF possesses a density greater than 1.35 g/cm³ and a substantially homogeneous crosslinked thermoset morphology along a radial dimension of the oxidized PAN fiber. Flame-retarded materials containing the resulting OPF, as well as methods for producing such flame-retarded materials, are also described.

### CROSS REFERENCE TO RELATED APPLICATIONS

The application is a divisional of U.S. application Ser. No. 13/163,134, filed on Jun. 17, 2011, the content of which in its entirety is incorporated herein by reference.

This invention was made with government support under Prime Contract No. DE-AC05-00OR22725 awarded by the U.S. Department of Energy. The government has certain rights in the invention.

### FIELD OF THE INVENTION

The present invention relates, generally, to processes for oxidizing PAN fiber, and more particularly, flame retardant materials made by such processes.

### BACKGROUND OF THE INVENTION

The Limiting Oxidation Index (LOI) is a primary characteristic for assessing the flame-retardance of a material. The LOI is generally defined as the lowest concentration of oxygen in the atmosphere, typically expressed as a percent, that will support sustained combustion of the material. Typically, an increase in the density of a PAN fiber increases its LOI value, and hence, its flame-retardant properties. Generally, materials with an LOI of greater than 25% can be considered flame-retardant. Another desirable attribute for a flame retardant is a suitably low exotherm. It is also desirable for the flame retardant material to have the capability of being adjusted in physical properties, such as strength and elongation characteristics. There is a continuing need in the art to find new materials having improved flame retardancy along with acceptable and adjustable mechanical properties.

With respect to the process for producing the flame retardant material, the processing time is a significant process parameter that directly affects the final production costs. Other processing conditions, such as temperature, also have a substantial impact on the financial viability of the process, particularly when such process is a large-scale industrial process. Accordingly, there is a need in the art to not only produce improved flame retardant materials, but to produce them by means that are more cost-effective and efficient.

### SUMMARY OF THE INVENTION

In the process described herein, PAN fiber is subjected to an advanced oxidation process in which rapid and aggressive oxidizing conditions are employed to create an oxidized PAN fiber (OPF) possessing a degree of crosslinking and corresponding density far greater than what would be useful in an OPF intermediate used in producing carbon fiber. The instant OPF would not be considered as an intermediate for the production of carbon fiber since the resulting carbon fiber would have completely undesirable mechanical attributes, such as extreme brittleness, lack of elasticity, and substandard strength. Although the oxidized PAN fiber produced by the instant method is not suitable as an intermediate for producing carbon fiber (i.e., by a subsequent carbonization step), it possesses exceptional flame retardant properties along with advantageous mechanical properties. Furthermore, by appropriate adjustment of process conditions, the instant process can fine-tune the mechanical properties of the oxidized PAN fibers. In some applications, an acceptable level of “elongation at break” (break strain) is desirable. For example, in fabric applications, a minimum of 8-12% elongation is desirable. The level of crosslinking can be carefully controlled to achieve an acceptable degree of elongation.

In particular embodiments, the method includes subjecting a PAN fiber to an oxidation process in which reactive oxidizing species produced by the oxidation process are maintained in close enough proximity to the PAN fiber during the oxidation process such that a core of the PAN fiber is converted to a crosslinked thermoset morphology before an oxidized shell of the PAN fiber becomes thick enough to substantially inhibit penetration of the reactive oxidizing species into the core. Preferably, the resulting oxidized PAN fiber possesses a density greater than 1.35 or 1.4 g/cm³ (1.35 or 1.4 g/cc) and possesses a substantially homogeneous crosslinked thermoset morphology along a radial dimension of the oxidized PAN fiber.

The invention is also directed to methods for forming a flame retardant material, such as a textile, which can be an article of clothing. In particular embodiments, the method includes partially oxidizing PAN fibers up to a density of about 1.35 or 1.4 g/cm³, weaving the partially oxidized PAN fibers with fibers of a textile to be flame retarded to form a preform, and further oxidizing the preform until the weaved PAN fibers possess a density greater than the density of the partially oxidized PAN fibers. The invention is also directed to the resulting flame-retarded material.

In contrast to the methods described herein, the most oxidized PAN fibers used in the manufacture of carbon fiber for structural applications (i.e., a density around 1.35 g/cm³, and, more typically, no more than 1.38 g/cm³) hardly possess any useful flame retardant properties. Although it may be possible to achieve significantly more oxidized (and hence, crosslinked) PAN fiber by subjecting the PAN fiber to longer processing times using conventional processes, this has been not practiced in the art since OPF has heretofore traditionally only been considered as an intermediate for carbon fiber production, and, as discussed above, such highly oxidized PAN fiber would result in carbon fibers with highly undesirable mechanical properties.

Moreover, by conventional oxidation processes, the production of such highly oxidized PAN fibers would take an excessive period of time, which would also be logistically impractical and financially unfeasible for industrial-scale production. For example, it is common in the industry to oxidize at around 250° C. to reduce the required processing time to around 80-120 minutes to achieve densities below 1.4 g/cm³. The instant method is particularly advantageous in that it can achieve highly crosslinked PAN fibers with densities well over 1.4 g/cm³ in significantly less time than possible with conventional processes. The produced fibers also possess physical characteristics (e.g., a substantially homogeneous crosslinked thermoset morphology) that results in improved integrity during use, such as resistance to chemical attack and blow-out under high temperature conditions.

### BRIEF DESCRIPTION OF THE DRAWINGS

FIG. 1. Schematic illustration showing the distinct cross-sectional regions in a PAN fiber oxidized by a conventional process.

FIG. 2. Illustration depicting a conventional apparatus for a PAN oxidation process.

FIG. 3. Illustration depicting an exemplary modified apparatus for achieving the advanced oxidation process of the instant invention.

FIG. 4. Graph showing variation of diameter ratio of hollow filaments obtained from hot sulfuric acid digested oxidized fibers for a range of processing (oxidation) times, wherein “diameter ratio” refers to inner ratio (ID) over outer diameter (OD), i.e., ID/OD. Data for both conventional and herein-described advanced oxidized fibers are displayed.

FIG. 5. Graph showing density profiles vs. processing time for PAN fibers in conventional and herein-described advanced oxidation processes.

FIG. 6. Graph showing differential scanning calorimetry (DSC) thermograms of oxidized PAN fibers.

FIG. 7. Graph showing x-ray diffraction (XRD) 20 profiles of PAN fibers (D stands for density in g/cm³).

FIG. 8. Scanning electron microscope (SEM) micrographs of oxidized PAN filaments subjected to core digestive treatment in concentrated sulfuric acid, wherein the oxidized PAN filaments shown on the left were oxidized by the herein-described advanced oxidation process, and the oxidized PAN filaments shown on the right were oxidized by a conventional oxidation process.

FIG. 9. Dynamic mechanical analysis (DMA) data showing storage moduli of conventionally oxidized PAN fibers (Fortafil) and advanced oxidized tows of different densities.

FIG. 10. Dynamic mechanical analysis (DMA) data showing loss moduli of conventionally oxidized PAN fibers (Fortafil) and advanced oxidized tows of different densities.

FIG. 11. Graph showing limiting oxidation index (LOI) vs. density for oxidized PAN fibers.

### DETAILED DESCRIPTION OF THE INVENTION

In one aspect, the invention is directed to a method for producing an oxidized PAN fiber. In the method, PAN fiber (typically as a tow) is subjected to a rapid aggressive oxidation (i.e., advanced oxidation) process in which reactive oxidizing species (ROS) are made to consistently attack the fiber before the reactive oxidizing species substantially decay in activity, as, for example, occurs when the ROS contact walls of a reactor in which the oxidation is being conducted. The advanced oxidation method achieves this by suitably minimizing the distance (i.e., maintaining a close enough proximity) between the reactive oxidizing species and the PAN fiber, as well as the flow rate of reactive oxidizing species, temperature, and other variables, so as to maximize attack on the fiber by non-decayed ROS. As used herein, the terms “advanced oxidation” and “advanced oxidized” refer to the inventive oxidation process described herein, which is an improvement on conventional oxidation processes known in the art.

The reactive oxidizing species considered herein are those species that are reactive enough to last fleetingly (typically, for a few seconds), and which are generally produced in situ by breakdown of other more stable species. The reactive oxidizing species are often radicals, or ions, or other highly unstable molecules, generally significantly more reactive than diatomic oxygen. In particular embodiments, the reactive oxidizing species are oxygen-containing reactive radicals. The oxygen-containing species can be produced by, for example, an oxygen or oxygen-containing plasma, or by a chemical or thermal decomposition process, such as an ozone decomposition process. The plasma process can be practiced as, for example, a remote indirect exposure configuration (i.e., where plasma generator is separate from the fiber, and the reactive gas is pumped to the furnace volume), or a close-proximity indirect exposure configuration (i.e., where fiber and plasma share the same volume, but are not in direct contact), or a direct exposure configuration (i.e., where the fiber is immersed completely in the plasma volume).

In particular embodiments, the reactive oxidizing species is or includes oxygen atoms and/or atomic or molecular oxygen ions, which may be one or more excited state monoatomic oxygen species. The production of reactive oxidizing species by use of an oxygen-containing plasma is well known in the art, such as described in U.S. Pat. Nos. 7,534,854 and 7,786,253, the contents of which are incorporated herein by reference in their entirety. The production of reactive oxidizing species by decomposition of ozone is also well known in the art, such as described in U.S. Pat. No. 7,649,078, the contents of which are incorporated herein by reference in their entirety.

By virtue of the low molecular weight of most reactive oxidizing species, such as monoatomic oxygen, the reactive oxidizing species more easily infiltrate the fiber to reach the core of the fiber. Thus, attack of the reactive oxidizing species on the fiber results in a rapid and simultaneous oxidation of all parts of the fiber, including the core. In contrast, a conventional process that does not utilize reactive oxidizing species (e.g., conventional air or oxygen process), or that does not include safeguards to minimize their decomposition before attacking the fiber, results in the production of a progressively thickening surface layer of highly oxidized and crosslinked material while leaving a core area that is substantially not as oxidized and much less crosslinked. In turn, the increasingly thickened oxidized surface increasingly inhibits penetration of the oxidizing species (particularly ROS) to the core, making the fiber increasingly impermeable to oxidizing species, including reactive oxidizing species. Therefore, as the fiber is oxidized in the conventional process, the fiber increasingly maintains a core of less oxidized material susceptible to blow-out even as the oxidation process is continued or made harsher. Moreover, modifying conventional oxidation methods by simply prolonging or elevating the temperature of the process does not result in substantially homogeneous fiber with an overall 3D-crosslinked thermoset morphology, as in the instant OPF, nor does such an approach result in OPF having the combination of density and superior mechanical properties of the instant OPF.

The advanced oxidation process of the instant invention achieves a substantially homogeneous oxidized PAN fiber with overall 3D-crosslinked thermoset morphology by exposing the fiber to reactive oxidizing species from the outset and continuously through the oxidation process before a recalcitrant oxidized shell is allowed to form. In this way, by maintaining non-decayed ROS on the PAN fiber, the entire fiber, including the core, oxidizes rapidly, at once, thereby resulting in a substantially homogeneous morphology along a radial dimension of the fiber.

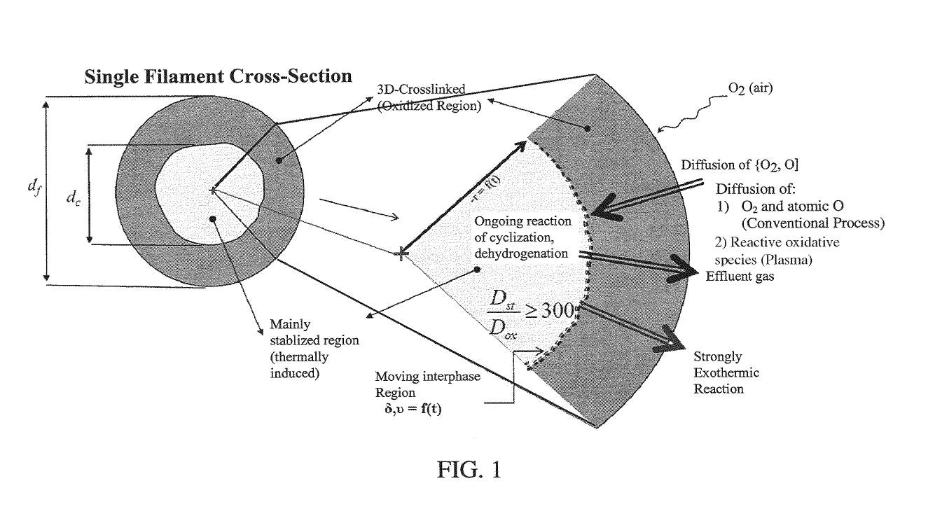

An oxidized PAN fiber produced by a conventional process as an intermediate for carbon fiber production generally exhibits a two-zone morphology (see FIG. 1) containing an outer region characterized by three-dimensional (3D)-crosslinking (bonding along the polymer length and across polymer chains), as well as a central (core) region characterized by a low-level crosslinked two-dimensional (2D)-ladder structure, wherein d_{f} is the diameter of the filament, d_{c} is the diameter of the core of the filament, D_{A} is the diffusion coefficient of oxygen across the chemically stabilized (2D crosslinked) PAN material, and Dₒₓ is the diffusion coefficient of oxygen across the chemically oxidized (3D crosslinked) PAN material. In contrast, the flame-retardant fiber produced herein exhibits a substantially homogeneous morphology of three-dimensional (3D)-crosslinked polymeric chains. At least one significant drawback of having a two-zone morphology of the art is that the low-crosslinked core region is susceptible to blow-out if subsequent carbonization takes place. This is very prominent when the densities of the core are very low. Thus, relative to conventional OPF, the instant fibers possess a higher level of mechanical integrity under typical operating conditions.

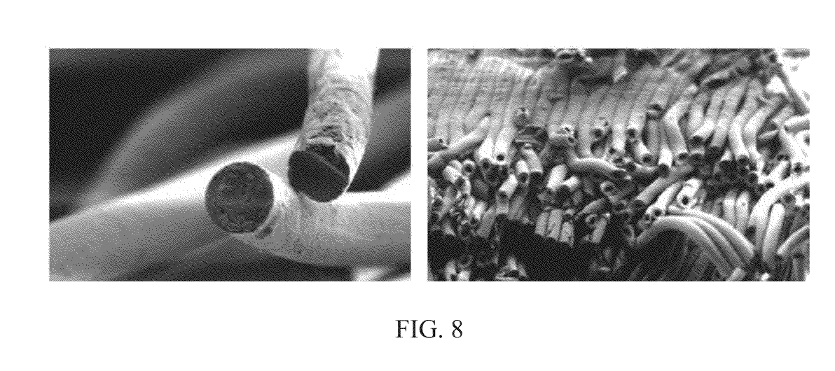

The two-zone morphology can be demonstrated by acid digestion analysis. The stabilized cores (that is, only chemically stabilized with a 2D ladder molecular structure and not oxidized) can be dissolved with concentrated acid, creating either a large depression in the frontal surface of the filament, or a hollow core through the entire length of the filament, depending on the degree of stabilization. In the latter case, the filament will be similar to a tube. For structural applications, many conventionally oxidized fibers, despite the fact that they are designated as “fully oxidized” when subjected to the acid test, will generate a depression in the center of the filament indicating that the filament is not fully chemically crosslinked and oxidized across the filament diameter. The oxidized PAN fibers produced by the advanced oxidation methods described herein do not produce tubular structures when treated by the acid test. FIG. 8 compares digested conventional OPF (right) with digested advanced oxidation OPF (left). As shown, the conventional OPF become hollowed, whereas the instant advanced oxidized OPF do not show this effect.

In particular embodiments, substantially non-decayed ROS is maintained on the fiber by flowing the ROS with minimal turbulence (i.e., non-turbulently) in a direction parallel to the walls of a chamber in which the PAN is housed during the oxidation process. In more particular embodiments, the process modifies a conventional oxidation process, as described, for example, in U.S. Pat. No. 7,649,078, herein incorporated by reference. The normal procedure at the time was to force the gas into the tube wherever the fiber enters (top or bottom), and force it out where the fiber exits (top or bottom). This would go either with or against the natural convective flow of the vertically-aligned tube (the chimney effect), depending upon the direction of fiber travel.

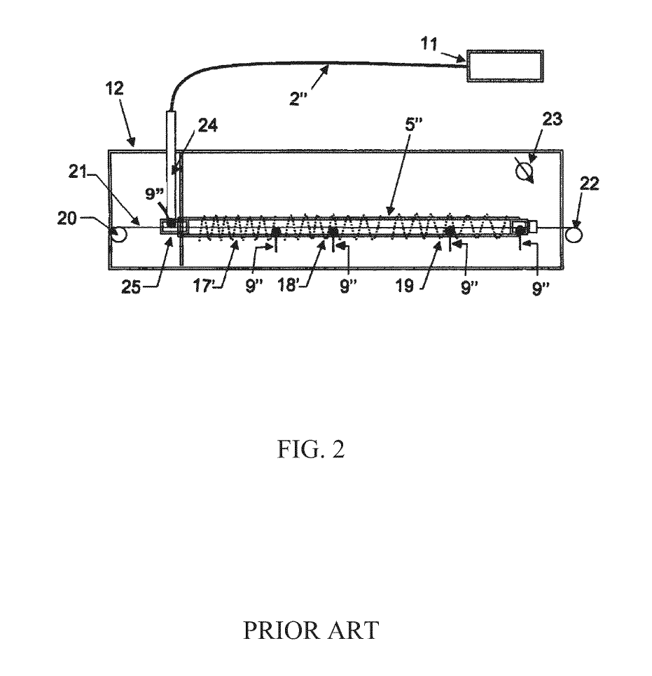

A conventional oxidation apparatus is shown in FIG. 2, which is a substantial reproduction of an apparatus shown in U.S. Pat. No. 7,649,078. The apparatus shown in FIG. 2 is configured to contain several heaters and a lengthy processing chamber so that the fibers have a greater residence time for a given line speed. This allows the fiber to proceed through a more gradual temperature gradient and to be processed at a higher line speed. Ozone or other reactive species is supplied from element 11, which is situated separately from the fiber processing unit that is enclosed in a safety enclosure chamber 12. The ROS is transferred via. PTFE hose 2″ to an inlet preheater 24 connected to one side of a tee 25. The other side of the tee is connected to a quartz tube 5″ that has three separately heated sections 17′, 18′, 19. Each heated section (5″, 9″, and 11″ long, respectively) consists of heater wire wound externally around the quartz tube 5″ and each is equipped with a thermocouple 9″ to monitor the internal temperature. This reactor also features two additional thermocouples 9″ to monitor the inlet and exit temperatures of the quartz tube. Supplied from a reel 20, the precursor tow 21 consisting of PAN fiber filaments is fed through the heated tube to a take-up reel 22. The interior of the enclosure is preferably maintained at slightly negative pressure via an exhaust port 23.

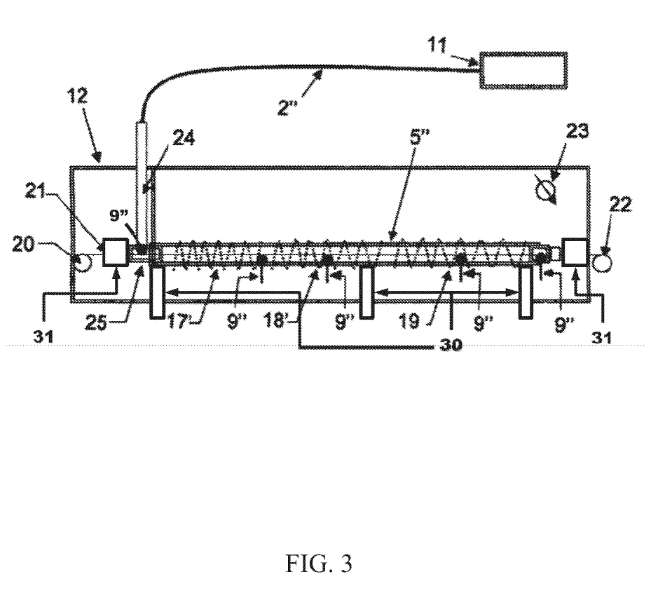

In a particular embodiment of the instant process, the conventional apparatus and process depicted in FIG. 2 is modified to manipulate both the natural convective flow and the forced gas flow to create a near-laminar flow condition at low velocity inside the tube in order to maximize the contact time between the reactive species of the gas and the fiber. By using the near-laminar flow condition, a sharp increase in OPF density was produced using otherwise identical conditions, such as temperature, fiber residence time, and power. Numerous methodologies and variations may be used to manipulate the flow rate to achieve a near-laminar flow condition. FIG. 3 depicts a particular methodology in which the conventional process shown in FIG. 2 is modified by including therein additional gas ports 30 and flow constrictors 31. One skilled in the art can suitably adjust the flow rate using such gas ports and flow constrictors to produce a near-laminar flow condition.

The theoretical premise for the instant approach is as follows. The half-life of the reactive species that reach the reaction chamber is drastically reduced when contact occurs with solid surfaces, especially heated surfaces. When reactive oxidizing species are destroyed, their breakdown components are even more reactive for a very short period of time. This phenomenon can be taken advantage of only if the flow conditions permit it. In a turbulent flow condition, the gaseous species are highly distributed and moving at high velocities and in random directions. While sometimes this is an advantage, for purposes of the instant invention, this is a disadvantage since the driving force behind contact time with the fiber becomes simply a ratio of surface area of the interior tube walls versus the surface area of the fiber. In addition, the chance of a set amount of reactive species impacting the reactor wall before impacting the fiber downstream from the injection point is very high. However, in a laminar flow case, the gaseous species, while not as well distributed, are moving at much lower velocities, and in the general direction of flow parallel to the reactor walls. In this case, the lower velocities allow for a higher probability of contact between the reactive species and the fiber, while at the same time increasing the survivability of such species downstream from the injection point. Therefore, a laminar flow at a very low velocity (with respect to fiber velocity) has herein been found to be much more advantageous for rapidly oxidizing PAN fiber than a turbulent flow at high velocities.

In a series of experiments, the flow configuration was altered via both hardware modifications and flow rates in and out of a vertical tube. In order to achieve a near-laminar flow, the natural convective flow was initially allowed to be dominant. Forced exhaust flow was eliminated, while methods of flow introduction were analyzed as well. Initially, one tube was modified, then three tubes, and then six tubes. Success was achieved early on, and a critical parameter space was established which produced very high density with acceptable mechanical properties at a very rapid rate. It can be concluded that, in fact, the laminar-low velocity flow condition is a primary cause of the increased rate of oxidation.

The number of ports may be widely varied in the embodiment shown in FIG. 3. For example, in some embodiments, a larger number of gas ports (e.g., four, five, six, seven, or more) may be found to be more ideal in manipulating the flow. The optimal number of gas ports and constrictors also depends on the length and size of the tube, and many other processing conditions.

By being “substantially homogeneous”, the oxidized PAN fibers produced by the instant method do not include discrete core and shell regions as found in the art. Instead, the instant oxidized PAN fibers are characterized by a single 3D-crosslinked thermoset morphology (i.e., completely homogeneous), or alternatively, an insignificantly narrow less-crosslinked core that would not be capable of causing blow out, or alternatively, a shallow gradient in which the degree of crosslinking gradually increases from the core radially outward to the surface of the fiber. By being an “insignificantly narrow core”, the core of less-crosslinked material is generally no more than 25% of the diameter of the PAN fiber. Moreover, in some embodiments, the less-crosslinked core considered herein is also 3D-crosslinked and thermoset. By being a “shallow gradient” is generally meant that the degree of crosslinking (i.e., density) does not vary by more than about 5% or 10% from core to surface of the fiber.

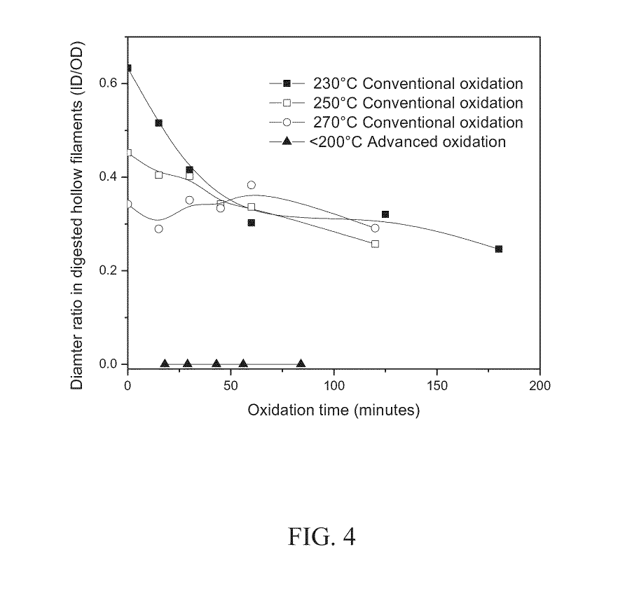

As depicted in FIG. 4, the conventional oxidation of a typical aerospace quality precursor in air leaves the mass of >0.2 fraction of diameter at the core of a filament 2D-crosslinked even after 120 minutes of soak time at 230-270° C. and preheating to the specific temperature from room temperature at <10° C./min. The 2D-crosslinked mass can be easily dissolved by hot sulfuric acid. The same precursor when oxidized by ROS it forms nearly homogeneous 3D-crosslinked mass within 18 minutes. The filaments oxidized by ROS at residence time greater than or equal to 18 minutes does not leave any hollow core when digested with hot acid. Thus, the resulting oxidized PAN fiber possesses a density (or average density) greater than 1.35 or 1.4 g/cm³, at least within 25% radial distance from the outer surface, while at least the next 50%, 60%, 70%, or 75% radial distance toward the core has a density of at least 1.4, 1.35, or 1.3 g/cm³. In other embodiments, the resulting oxidized PAN fiber possesses a density (or average density) greater than 1.4 g/cm³, at least within 50% radial distance from the outer surface, while at least the next 25%, 30%, 40%, or 50% radial distance toward the core has a density of at least 1.4, 1.35, or 1.3 g/cm³. In yet other embodiments, the resulting oxidized PAN fiber possesses a density (or average density) greater than 1.4 g/cm³, at least within 75% radial distance from the outer surface, while at least the next 5%, 10%, 15%, 20%, or 25% radial distance toward the core has a density of at least 1.4, 1.35, or 1.3 g/cm³.

In other embodiments, the resulting oxidized PAN fiber possesses a density (or average density) of at least or above 1.45, 1.5, 1.55, or 1.60 g/cm³, at least within 25% radial distance from the outer surface, while at least the next 50%, 60%, 70%, or 75% radial distance toward the core has a density of at least or above 1.6, 1.55, 1.5, 1.45, 1.4, 1.35, or 1.3 g/cm³. In other embodiments, the resulting oxidized PAN fiber possesses a density (or average density) of at least or above 1.45, 1.5, 1.55, or 1.60 g/cm³, at least within 50% radial distance from the outer surface, while at least the next 25%, 30%, 40%, or 50% radial distance toward the core has a density of at least or above 1.6, 1.55, 1.5, 1.45, 1.4, 1.35, or 1.3 g/cm³. In yet other embodiments, the resulting oxidized PAN fiber possesses a density (or average density) of at least or above 1.45, 1.5, 1.55, or 1.60 g/cm³, at least within 75% radial distance from the outer surface, while at least the next 5%, 10%, 15%, 20%, or 25% radial distance toward the core has a density of at least or above 1.6, 1.55, 1.5, 1.45, 1.4, 1.35, or 1.3 g/cm³. In other embodiments, the oxidized PAN fibers are characterized by an overall homogeneous density, or average density, of precisely, about, at least, or greater than 1.45, 1.5, 1.55, or 1.60 g/cm³.

The advanced oxidation method described above can advantageously produce high-density, highly flame retardant oxidized PAN fibers in shorter time periods compared to conventional processes of the art for achieving the same or even lower densities. In different embodiments, the processing time (i.e., time in which the fiber is subjected to the oxidizing conditions) is no more than, or less than 90, 80, 70, 60, 50, 45, 40, 30, 20, or 10 minutes to achieve a density of at least or greater than 1.3, 1.35, 1.4, 1.45, 1.5, 1.55, or 1.6 g/cm³, or a higher density.

The method described herein is even further advantageous in that it can achieve such high densities, in the modest times indicated, by use of moderate to low temperatures compared to those typically used in the art. Generally, the temperature used in the advanced oxidation process described herein is in the range of 120-260° C. In different embodiments, the temperature can be selected to be precisely, about, up to, or less than, for example, 260° C., 255° C., 250° C., 245° C., 240° C., 235° C., 230° C., 225° C., 220° C., 215° C., 210° C., 200° C., 190° C., 180° C., 170° C., 160° C., 150° C., 140° C., 130° C., or 120° C. The temperature may also be within a range bounded by any two of the foregoing exemplary temperatures. For example, in different embodiments, the temperature may preferably be in a range of 130-260° C., 140-260° C., 150-260° C., 160-260° C., 170-260° C., 180-260° C., 190-260° C., 200-260° C., 210-260° C., 220-260° C., 120-230° C., 130-230° C., 140-230° C., 150-230° C., 160-230° C., 170-230° C., 180-230° C., 190-230° C., 200-230° C., 210-230° C., 120-220° C., 130-220° C., 140-220° C., 150-220° C., 160-220° C., 170-220° C., 180-220° C., 190-220° C., 200-220° C., 210-220° C., 120-200° C., 130-200° C., 140-200° C., 150-200° C., 160-200° C., 170-200° C., 180-200° C., or 190-200° C.

In some embodiments, the temperature is held substantially or precisely constant. In other embodiments, the temperature is varied. In one embodiment, the temperature is varied by raising the temperature and/or lowering the temperature by a specified rate during the oxidation process. Temperature variation may also be interrupted one or more times by a temperature plateau, i.e., where temperature is maintained for a period of time at a particular temperature. In a particular embodiment, the temperature is raised to a peak temperature, optionally maintained at the peak temperature, before being lowered to a lower temperature or room temperature.

Another advantage of the oxidation method described herein is the ease with which a surface modification process can be integrated with the process. A surface modification process may have a variety of uses, such as, for example, to improve the integration of the fibers with a host matrix to be flame-retarded. Significantly, the instant oxidation process allows a surface modification process to be integrated without transferring the PAN fiber to a separate surface modification chamber. Thus, the PAN fiber, during or after the oxidation process, can be reacted with one or more surface reactive species that are introduced into the same chamber where the oxidation process is performed. Moreover, the surface modification process can be performed very quickly, particularly if the reactive species are introduced at the end of the oxidation process while the PAN fibers are elevated in temperature. In some embodiments, the surface modification process can be conducted in a few minutes, more preferably up to one minute, and more preferably less than one minute.

The one or more surface reactive species are any species reactive enough, under appropriate conditions of temperature and processing time, to chemically modify the surfaces of oxidized PAN fiber. In some embodiments, the surfaces of oxidized PAN fiber are chemically modified to include nitrogen-containing groups, such as amine groups. Some examples of reactive chemical species capable of introducing nitrogen-containing groups on the surface of oxidized PAN fiber include ammonia, guanidine, methylamine, ethylamine, and dimethylamine. In other embodiments, the surfaces of oxidized PAN fiber are chemically modified to include oxygen-containing groups, such as hydroxyl, carbonyl, and carboxylic acid groups. Some examples of reactive chemical species capable of introducing oxygen-containing groups on the surface of oxidized PAN fiber include water, hydrogen peroxide, organic peroxides, and alcohols.

Numerous other surface derivatizing groups are possible. For example, hydrogen sulfide or another mercaptan can be included to incorporate sulfur-containing groups, such as thiol groups, on the surface. A silicon-containing group, such as silane, an organosilane, or siloxane, can be included to introduce silyl groups on the surface. A phosphorus-containing group, such as phosphine or an organophosphine, can be included to introduce phosphino groups on the surface.

The starting and oxidized PAN fibers generally have a diameter of no more than about 30 microns (30 μm). The fiber diameter can be precisely, about, at least, up to, or no more than, for example, 5, 10, 15, 20, 25, or 30 μm. As used herein, the term “about” generally indicates within ±0.5, 1, 2, 5, or 10% of the indicated value (for example, “about 20 μm” can mean 20 μm±10%, which indicates 20±2 μm or 18-22 μm). Moreover, the end-products can be manufactured in many different forms and configurations. Continuous filaments or tows from very low count (<500) to very high counts (>500 k) can be manufactured via this technology. Such fibers can be also be stapled or chopped (short-segment). Either can be manufactured into a fiber, yarn, fabric, or felt.

The PAN fiber, before oxidation, can be any fiber known in the art that contains polyacrylonitrile (PAN). In some embodiments, the PAN-containing fiber or tow is composed solely of PAN. In other embodiments, the PAN-containing fiber or tow is composed of PAN and another (i.e., non-PAN) polymer. A PAN-containing fiber containing PAN and at least one non-PAN polymer is typically in the form of a PAN-containing copolymer. The copolymer contains PAN along with one or more types of non-PAN monomer units (or one or more blocks or segments of non-PAN polymer). The PAN in such copolymers can be in a primary amount (i.e., greater than 50 mol %), secondary amount (i.e., less than 50 mol %), or equal amount. The copolymer can be, for example, a block, random, alternating, or graft copolymer.

A PAN-containing fiber may also be composed of a non-copolymer composite of PAN and one or more other polymers. The composite can be in the form of, for example, an admixture of PAN and one or more non-PAN polymers, wherein the admixture may be homogeneous or heterogeneous. An example of a heterogeneous PAN-containing fiber composite is one that includes separate strands of PAN and non-PAN fibers (e.g., by interweaving or wrapping). In other embodiments, the PAN-containing fiber or tow is composed of both a copolymer of PAN and a homogeneous or heterogeneous composite of the PAN copolymer and one or more other polymers.

The non-PAN copolymer units are typically addition polymers derived from any of the unsaturated (generally, olefin) monomer precursors known in the art for producing such polymers. In particular embodiments, the non-PAN copolymer units are derived from unsaturated carboxylate precursor molecules, unsaturated amide precursor molecules, or a combination thereof. The unsaturated carboxylate precursor molecule generally contains at least one carbon-carbon double bond and a carboxylic acid or carboxylic ester group, wherein the olefinic group is often bound to the carbonyl carbon atom of the carboxylic acid or carboxylic ester group. Some examples of unsaturated carboxylate precursor molecules include methyl acrylate, ethyl acrylate, propyl acrylate, butyl acrylate, methylmethacrylate, (2-hydroxyethylacrylate), vinyl acetate, acrylic acid, methacrylic acid, and itaconic acid. The unsaturated amide precursor molecule generally contains at least one carbon-carbon double bond and an amide group (which can be N-substituted or N,N-disubstituted), wherein the olefinic group is often bound to the carbonyl carbon atom of the amide group. Some examples of unsaturated amide precursor molecules include acrylamide, methacrylamide, N-alkyl derivatives thereof, and N,N-dialkyl derivatives thereof.

In a first particular set of embodiments, the PAN fiber, before oxidation, contains at least 70 mol % acrylonitrile monomer units and up to 30 mol % of copolymer (i.e., non-acrylonitrile) units. In a second particular set of embodiments, the PAN fiber, before oxidation, contains at least 75 mol % acrylonitrile monomer units and up to 25 mol % of copolymer units. In a third particular set of embodiments, the PAN fiber, before oxidation, is comprised of at least 80 mol % acrylonitrile monomer units and up to 20 mol % of copolymer units. In a fourth particular set of embodiments, the PAN fiber, before oxidation, is comprised of at least 85 mol % acrylonitrile monomer units and up to 15 mol % of copolymer units. In a fifth particular set of embodiments, the PAN fiber, before oxidation, is comprised of at least 90 mol % acrylonitrile monomer units and up to 10 mol % of copolymer units.

The PAN fiber used before oxidation can be commercially obtained, or it can be produced by any of the methods known in the art. Some of the methods well known in the art for producing PAN fiber include melt spinning, solution spinning, and gel spinning techniques.

By controlling such factors as temperature, processing time, PAN fiber composition, and flow characteristics of the reactive atmosphere in the oxidation process, the mechanical properties of the oxidized PAN fibers can be tailored. Some mechanical properties that can be tailored include tensile strength, modulus, elongation at break (i.e., break strain), and toughness. The oxidized PAN fibers produced herein generally possess tensile strengths of at least 15 Ksi. In different embodiments, the oxidized PAN fibers have tensile strengths of precisely, about, up to, at least, or greater than, for example, 15, 20, 25, 30, 35, 40, 45, 50, or 60 Ksi. In different embodiments, the oxidized PAN fibers have moduli of precisely, about, up to, at least, or less than, for example, 0.5, 0.6, 0.7, 0.8, 0.9, 1, 1.1, 1.2, 1.3, 1.4, or 1.5 Msi. The oxidized PAN fibers produced herein generally possess an elongation at break of at least 1%. In different embodiments, the oxidized PAN fibers have an elongation at break of precisely, about, up to, at least, or less than, for example, 1, 2, 3, 4, 5, 6, 7, 8, 9, 10, 11, 12, 13, 14, 15, 16, 17, 18, 19, 20, 21, 22, 23, 24, or 25%.

As discussed earlier, the LOI value is a primary indicator of the flame retarding (or flame resistant) ability of a material. The oxidized PAN fibers described herein can generally possess a LOI value of at least 40. In different embodiments, the oxidized PAN fibers can possess a LOI value of precisely, about, at least, or greater than, for example, 40, 45, 50, 55, 60, 65, or 70%.

In another aspect, the invention is directed to methods for forming a flame-retarded material, which contains the above-described oxidized PAN fibers as a flame retardant component in a material to be flame-retarded. The material can be any material requiring flame retardancy in which oxidized PAN fiber can be incorporated. The material can be, for example, a layer, sheet, or film of a plastic, polymer, or cellulosic material. If the host material is meltable, the oxidized PAN fiber can be mixed with the melted host followed by solidification. If the host material is not meltable, or melting is to be avoided, the oxidized PAN fiber can be introduced by, for example, comminuting the host material, mixing with the fiber, and melt-pressing or pressure-welding. The oxidized PAN fiber can be included in any suitable amount in the flame-retarded material, which can be an amount over 0% and under 100%. In different embodiments, the oxidized PAN fiber can be included in an amount of precisely, about, at least, up to, or less than, for example, 1%, 2%, 5%, 10%, 15%, 20%, 25%, 30%, 40%, 50%, 55%, 60%, 65%, 70%, 75%, 80%, 85%, 90%, or 95% by weight of the flame-retarded material. The amount of oxidized PAN fiber may also be within a range bounded by any of these exemplary values. For example, in different embodiments, the amount of oxidized PAN fiber may preferably be within a range of 1-80%, 5-80%, 10-80%, 20-80%, 30-80%, 40-80%, 50-80%, 60-80%, 70-80%, 10-75%, 20-75%, 30-75%, 40-75%, 50-75%, 60-75%, 10-70%, 20-70%, 30-70%, 40-70%, 50-70%, 60-70%, 10-65%, 20-65%, 30-65%, 40-65%, 50-65%, 10-60%, 20-60%, 30-60%, 40-60%, 50-60%, 5-50%, 10-50%, 20-50%, 30-50%, 40-50%, 5-40%, 10-40%, 20-40%, or 30-40%.

In particular embodiments, the material to be flame-retarded is a textile. The textile can be, for example, a fabric. The fabric is often composed of strands of a textile material. In particular embodiments, the fabric is a fabric used in clothing, which also includes specialty apparel (e.g., gloves, coats, shoes, and the like). In other embodiments, the fabric is in a functional textile, such as flooring (e.g., a rug) or tarp. Some examples of fabrics that can be flame-retarded include cotton, polyester, nylon, silk, wool, rayon, cellulose acetate, spandex, and blends thereof.

In particular embodiments, fibers of the textile material and oxidized PAN fibers are interweaved to form a flame-retarded version of the fabric. However, oxidized PAN fibers having a density of over 1.4 g/cm³ are highly inflexible, and hence, not amenable to being weaved. To overcome this, the invention is also directed to a two-stage oxidation and interweaving process wherein PAN fibers are partially oxidized to a density less than 1.4 g/cm³, (generally, at least 1.3, 1.32, or 1.35 g/cm³ and up to 1.36, 1.37, or 1.38 g/cm³) at which lower density the partially oxidized PAN fibers are generally flexible enough to be weaved with strands of fabric, followed by a second stage of oxidation during which the partially oxidized PAN fibers (now interweaved with fabric) are further oxidized by methods described above to achieve a density of precisely, at least, or greater than 1.35, 1.37, 1.4, 1.42, 1.45, 1.47, 1.5, 1.52, 1.55, 1.57 or 1.6 g/cm³. Ina first particular set of embodiments, a flame-retarded textile or fabric is produced by partially oxidizing PAN fibers up to a density of precisely, about, or less than 1.3, 1.35, 1.37, or 1.4 g/cm³, weaving the partially oxidized PAN fibers with fibers of a textile to be flame retarded to form a preform, and further oxidizing the preform until the PAN fibers possess a density greater than the density of the partially oxidized PAN fibers. The final oxidized PAN fiber in the woven fabric can have a density of precisely, about, at least, or greater than, for example, 1.4, 1.42, 1.45, 1.5, 1.55, or 1.6 g/cm³.

Examples have been set forth below for the purpose of illustration and to describe certain specific embodiments of the invention. However, the scope of this invention is not to be in any way limited by the examples set forth herein.

### Example 1

### Preparation of Oxidized PAN Fiber Flame Retardant Via Advanced Oxidation with Remote Exposure

An advanced route (plasma-based method) was used to accelerate oxidation of PAN based fibers. A plasma generation system was fed a mixture of oxygen- and nitrogen-containing gases producing a gas feed containing a percentage of reactive species generated by the plasma discharge, such as trioxygen, monoatomic oxygen, nitrogen-based oxides, and other excited species and radicals. The relative concentrations and presence of these compounds were dependent on flow rate, pressure, and plasma electrical parameters. This reactive gas mixture was fed into the apparatus shown in FIG. 3 where the flow rate and injection geometry produced a close flow match to the natural convective flow produced by rising heat to create a near-laminar flow condition at low velocity inside the tube to maximize the contact time between the reactive species of the gas and the fiber itself. A sharp increase in OPF density was produced with otherwise identical conditions (temperature, fiber residence time, power, etc.) to previous work. The flow configuration was altered via both hardware modifications and flow rates in and out of the apparatus. In order to achieve a near-laminar flow, the natural convective flow was initially allowed to be dominant. Subsequent tests allowed the forced flow to become dominant. The apparatus was replicated and testing was performed on up to six tubes. A critical parameter space was established which produced very high density with acceptable mechanical properties at a very rapid rate. It was concluded that, in fact, a laminar/low velocity flow condition was an essential component to the rapid rate of oxidation.

Due to the precise interaction of the excited chemical species generated by the plasma volume with the fiber at the proper temperature, very high density fibers (>1.3 g/cc) were obtained. This invention describes an oxidation process for producing flame retardant PAN fiber that can be 3-4 times faster than conventional processes. The density, morphological characteristics, thermal behavior, and mechanical properties of the resulting fibers have been evaluated.

### Example 2

### Preparation of Oxidized PAN Fiber Flame Retardant Via Advanced Oxidation with Close-Proximity Indirect Exposure

Another advanced route (plasma-based method) was used to accelerate oxidation of PAN based fibers. A plasma volume was generated on the surface of an insulative material and brought into close proximity with the fiber material. With the same chemistry discussed in Example 1, gas flow was directed through the plasma volume to the fiber. The advantage of this method is the utilization of short-lived species in the oxidation process. Results similar to Example 1 were obtained.

### Example 3

### Preparation of Oxidized PAN Fiber Flame Retardant Via Advanced Oxidation with Direct Exposure

An additional example of an advanced route (plasma-based method) could be used to accelerate the oxidation process. Here, a plasma volume could be generated that completely encloses the fiber material. The chemical mechanisms would be the same as for Example 1. Additional care would need to be taken to not damage the fiber with this technique.

### Example 4

### Characterization of the Oxidized PAN Fiber Flame Retardant

The resulting oxidized PAN filaments exhibit a very high density (e.g., 1.4-1.7 g/cm³) and less remnant heat than the conventional PAN-based flame retardant fibers, as well as acceptable mechanical properties. Density data and corresponding processing time are displayed in Table 1 below.

TABLE 1
Density data vs. processing time

| | | Processing | Density | |
|---|---|---|---|---|
| | Processing | Time | (D) | Diameter |
| Sample ID | Type | (minutes) | (g/cm³) | (μm) |
| Adv Sample 1723 | Plasma | 40.9 | 1.5719 | 11.64 |
| Adv Sample 1749 | Plasma | 64.3 | 1.5329 | 11.58 |
| Adv Sample 1721 | Plasma | 40.9 | 1.5360 | 11.80 |
| Adv Sample 1750 | Plasma | 64.3 | 1.5028 | 11.56 |
| Adv Sample 1752 | Plasma | 64.3 | 1.4799 | 11.92 |
| Adv Sample 1754-55 | Plasma | 83.8 | 1.5182 | 11.45 |
| Adv Sample 1754 | Plasma | 42.9 | 1.4970 | 11.89 |
| Adv Sample 1722 | Plasma | 42.9 | 1.4961 | 11.94 |
| Adv Sample 1586 | Plasma | 18.0 | 1.3769 | 12.90 |
| Adv Sample 1552 | Plasma | 23.4 | 1.3839 | 12.70 |
| Adv Sample 1411 | Plasma | 28.4 | 1.3515 | 12.29 |
| Adv Sample 1427 | Plasma | 29.2 | 1.3378 | 12.14 |
| Adv Sample 1486 | Plasma | 29.2 | 1.3882 | 12.67 |
| Adv Sample 1496 | Plasma | 29.2 | 1.3914 | 12.94 |
| Aerospace 3 k-2 h | Conventional | 120 | 1.2821 | 12.04 |
| Aerospace 3 k-4 h | Conventional | 240 | 1.4651 | 11.38 |
| Aerospace 3 k-8 h | Conventional | 480 | 1.5532 | 10.95 |
| Aerospace 3 k-24 h | Conventional | 1440 | 1.6333 | 10.34 |
| Commodity-2 h | Conventional | 120 | 1.3397 | N/A |
| Commodity-4 h | Conventional | 240 | 1.4282 | N/A |
| Commodity-8 h | Conventional | 480 | 1.4891 | N/A |
| Commodity-24 h | Conventional | 1440 | 1.498 | N/A |

For the above table, under the “Sample ID” column, the following designations are defined:

Adv Sample—These are test results from the instant method that is plasma-based utilizing aerospace-grade PAN precursor. The number represents the experiment number ID.

Aerospace 3 k—These are test results from conventional processing techniques commonly found in the field utilizing aerospace-quality PAN precursor tows of 3000 filaments each.

Commodity—These are test results from conventional processing techniques commonly found in the field utilizing commodity-grade PAN precursor. For the latter two designations, the “-xh” represents the processing time, where “x” is the number of hours.

Under the “Processing Type” column, the “plasma” designation refers to the above-described plasma-based method, while the “conventional” designation refers to a conventional non-plasma-based process commonly used in the industry.

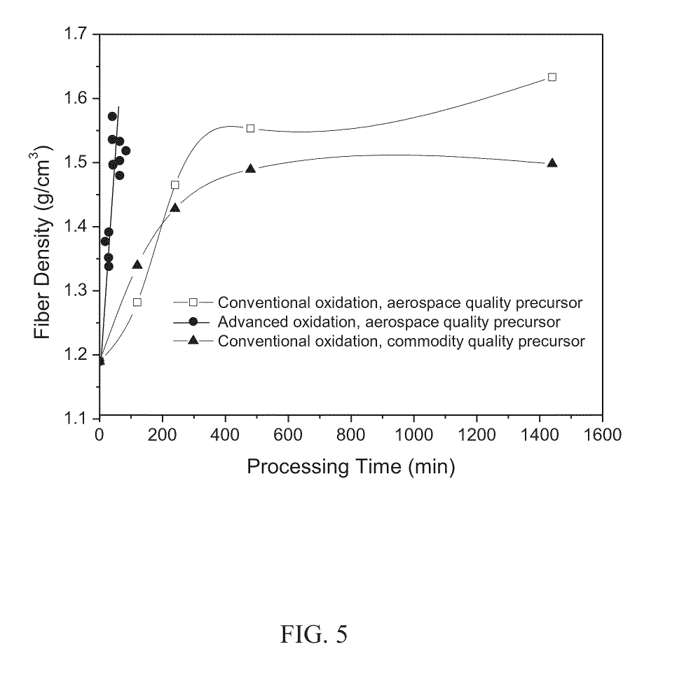

FIG. 5 indicates that the increased densities reported herein have been achieved by the instant advanced oxidation process in significantly shorter times as compared to conventional oxidation processes. For example, two conventional oxidation processes (i.e., aerospace and commodity conventional oxidation) are shown to take ca. 200 minutes and at least ca. 275 minutes to achieve densities of 1.4 g/cm³ and 1.5 g/cm³, respectively. In contrast, the herein-described advanced oxidation process can achieve these densities in less than 50 minutes and ca. 50 minutes, respectively.

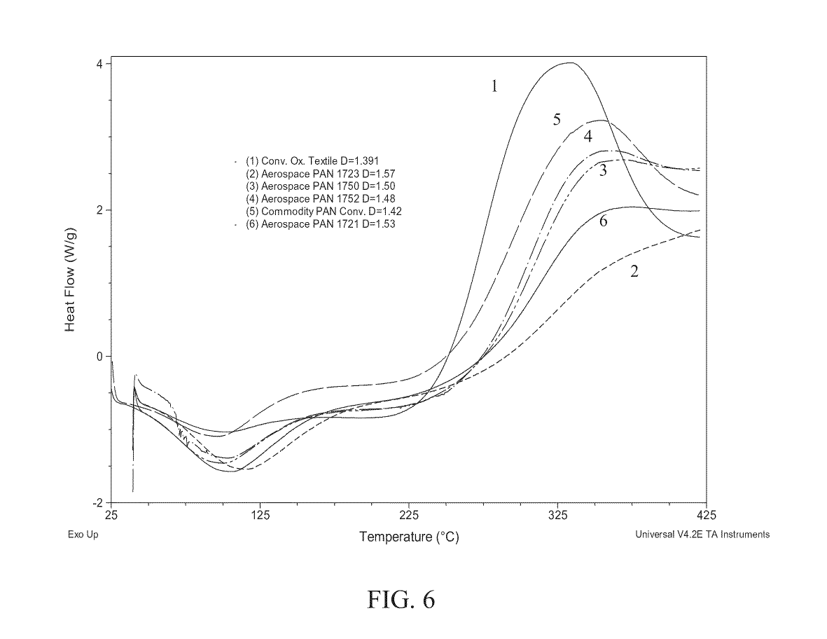

DSC thermograms of PAN fibers at different levels of advanced oxidation (i.e., of the instant invention) and conventional oxidation are displayed in FIG. 6. It is clear that advanced oxidized fiber has less remnant heat of reaction in air than the conventionally oxidized fibers. In particular, it is clear that relative to conventionally oxidized PAN fiber (e.g., commodity PAN Precursor), the advanced oxidized fiber has very little remnant heat of reaction. Thus, it has been shown that the instant advanced oxidation can induce a higher degree of exothermic oxidation reaction in the fibers than conventional methods. This indicates that the instant advanced oxidized PAN materials are more thermally inert compared to conventionally oxidized fibers.

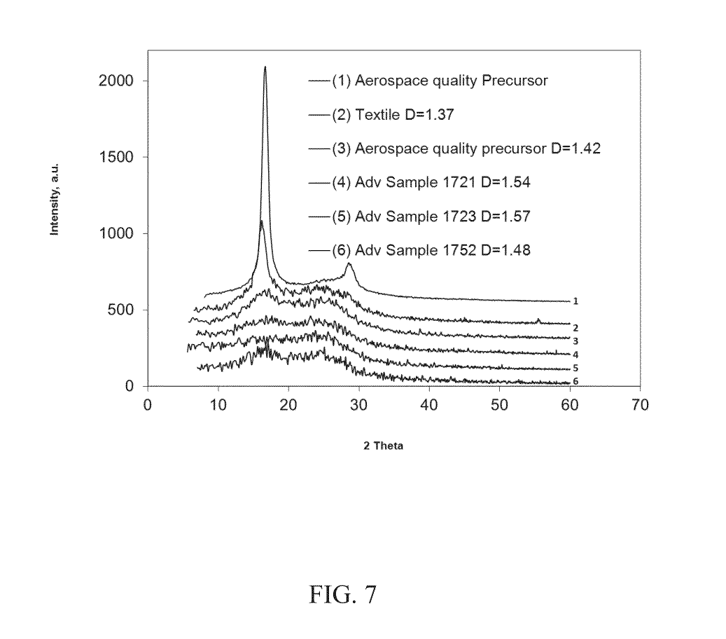

XRD data for the oxidized PAN fibers is shown in FIG. 7. The XRD data indicate that there is less degree of order (sharpness of the peak due to precursor fiber is reduced) for the advanced oxidized fibers compared to the conventionally oxidized textile fiber F886B D=1.37 g/cm³ and aerospace quality precursor D=1.42 g/cm³. This result is believed to be a result of the higher degree of oxidation in advanced processed fibers.

FIG. 8 shows scanning electron microscope (SEM) micrographs of oxidized PAN filaments subjected to core digestive treatment in concentrated sulfuric acid. The oxidized PAN filaments shown on the left were oxidized by the herein-described advanced oxidation process, and the oxidized PAN filaments shown on the right were oxidized by a conventional oxidation process. As the SEM images show, oxidation at the core is complete in the advanced oxidation process (as shown at left) as no hole is formed at the center after digestion. In contrast, conventionally oxidized PAN filaments become tubular after digestion due to the less-crosslinked core, which is prone to acid digestion (as shown on right).

Tensile data of the oxidized PAN fibers are summarized in Table 2 below. With an increase in density, the ultimate elongation decreases. Thus, the mechanical properties can be tailored, among other factors, by the degree of oxidation. The tensile data show that strength and elongation can vary from 17-45 ksi and 2-18%, respectively.

TABLE 2
Measured mechanical properties of filaments. Values in
parentheses indicate standard deviation.

| | Density (D) | Tensile | Modulus | Elongation |
|---|---|---|---|---|
| Fiber ID # | (g/cm³) | Strength (Ksi) | (Msi) | (%) |
| Adv Sample 1411 | 1.3515 | 29.8 (3.4) | 0.77 (0.21) | 5.86 (1.19) |
| Adv Sample 1427 | 1.3378 | 31.7 (3.1) | 0.88 (0.16) | 6.10 (1.39) |
| Adv Sample 1552 | 1.3839 | 33.2 (3.0) | 0.84 (0.17) | 14.58 (3.81) |
| Adv Sample 1586 | 1.3769 | 35.1 (2.4) | 0.82 (0.16) | 18.02 (4.52) |
| Adv Sample 1750 | 1.5028 | 20.0 (3.7) | 0.70 (0.30) | 3.15 (0.60) |
| Adv Sample 1496 | 1.3914 | 42.6 (3.4) | 0.90 (0.30) | 18.5 (4.3) |
| Adv Sample 1723 | 1.5719 | 20.2 (1.9) | 1.1 (0.20) | 2.02 (0.37) |
| Adv Sample 1752 | 1.4799 | 21.5 (4.2) | 1.2 (0.30) | 2.23 (0.55) |
| Adv Sample 1754- | 1.5182 | 17.1 (1.7) | 0.60 (0.20) | 3.27 (0.59) |
| 1755 | | | | |
| Conventional- | 1.4651 | 39.3 (5.4) | 0.93 (0.33) | 10.35 (1.87) |
| Aerospace 3 k | | | | |
| 4 hours | | | | |
| Conventional- | 1.6333 | 26.2 (2.6) | 0.09 (0.20) | 3.62 (0.66) |
| Aerospace 3 k | | | | |
| 24 hours | | | | |

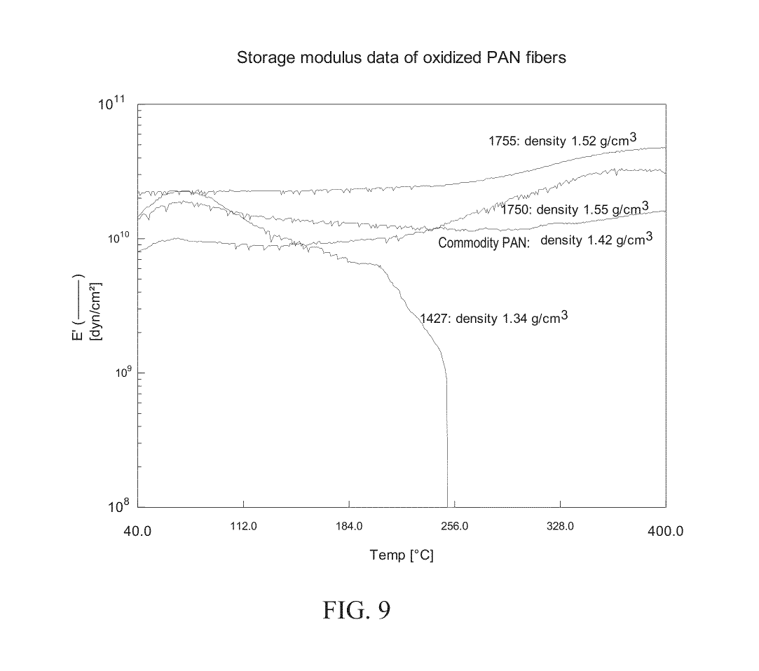

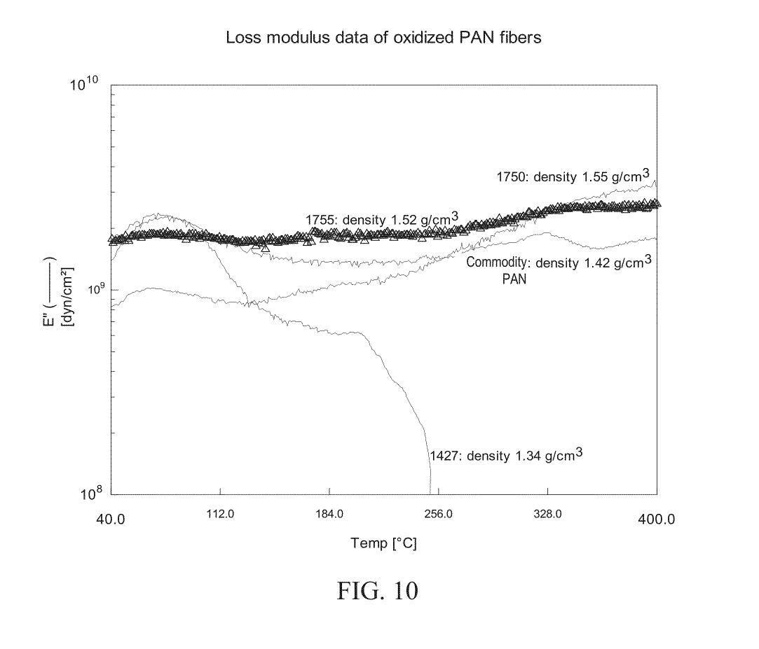

As shown in FIG. 9, low density OPF exhibits a significant drop in storage dynamic mechanical modulus beyond 200° C. With increasing density, the degree of crosslinking increases and the fibers exhibit high temperature resistance. For example, fibers with densities higher than 1.50 g/cm³ show increase in modulus beyond 250° C. This is likely due to pyrolysis of the mass (core), i.e., carbonization of part of the fiber. Conventionally oxidized commodity PAN fiber shows relatively less increase in modulus beyond 250° C. Property retention of oxidized fiber at elevated temperature is necessary for the flame retardant fibers. Advanced oxidized fibers demonstrate that criteria. Similar observations are made on loss modulus data shown in FIG. 10.

Commercial PAN-based flame retardant fibers prepared by conventional oxidation methods generally possess a lower density when compared to advanced oxidized fibers. Commercial oxidized PAN fiber shows a drop in mechanical properties beyond 250-300° C., depending on heat exposure time. Although those are static tensile measurements, this trend is somewhat similar to the storage modulus data for low density fiber (FIG. 9). As demonstrated in the dynamic mechanical analysis data of both FIGS. 9 and 10, PAN fibers made via the advanced oxidation method and with high densities are more capable of retaining static mechanical properties at significantly elevated temperatures.

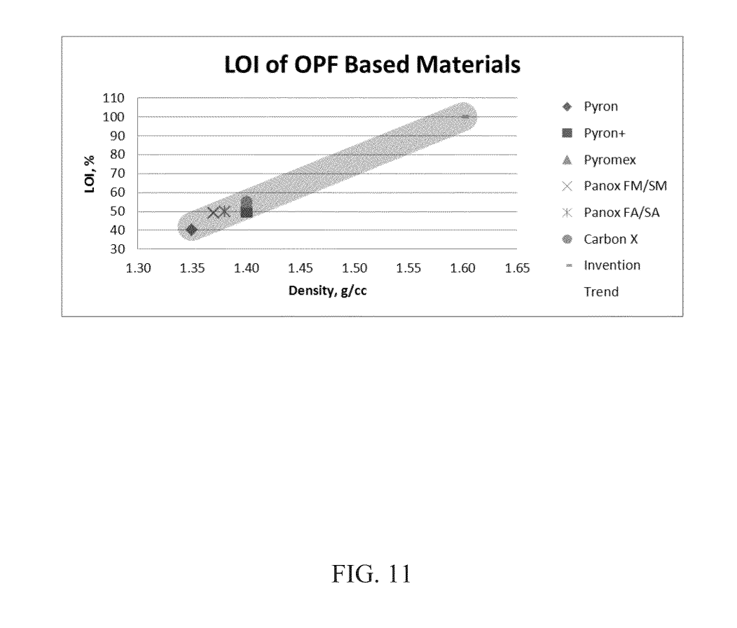

A comparison of LOI vs. density is charted in FIG. 11. The products derived from PAN, as are the fibers produced in this disclosure, are Panox® (SGL), Pyron® (Zoltek), Pyromex® (TohoTenax), and Carbon X® (Chapman). Note that the density of Carbon X® is an estimate. A significant fact to be appreciated from this data is that LOI increases with density. As LOI is a measure of flame retarding ability, it is generally understood that flame retarding ability increases with density. Thus, the high densities achieved by the herein-described advanced oxidation method, as shown in FIG. 5, correlate with significantly increased LOI, which correlate with significantly increased flame retarding ability.

Moreover, as shown by FIG. 5, the processing times required to achieve high densities of over 1.4 g/cm³ by conventional oxidation processes are significantly longer than the processing times used in the instant advanced oxidation process for achieving such high densities. Furthermore, as also revealed in FIG. 5, it takes much longer to increment the density of PAN during oxidation from 1.37 to 1.40 g/cm³ in contrast to going from 1.21 to 1.24 g/cm³. Thus, a key advantage of the present invention is that it provides a rapid and low-cost method for the production of extremely high density OPF, which correlates with OPF having a significantly increased LOI, and thus, substantially improved flame retardant ability.

While there have been shown and described what are at present considered the preferred embodiments of the invention, those skilled in the art may make various changes and modifications which remain within the scope of the invention defined by the appended claims.

1.-17. (canceled)

18. A method for producing an oxidized PAN fiber, the method comprising subjecting a PAN fiber to an oxidation process in which reactive oxidizing species produced by said oxidation process are maintained in close enough proximity to said PAN fiber during the oxidation process such that a core of the PAN fiber is converted to a crosslinked thermoset morphology before an oxidized shell of the PAN fiber becomes thick enough to substantially inhibit penetration of said reactive oxidizing species into said core, wherein said oxidized PAN fiber possesses a density greater than 1.3 g/cm³ and a substantially homogeneous crosslinked thermoset morphology along a radial dimension of the oxidized PAN fiber.

19. The method of claim 18, wherein said density is at least 1.35 g/cm³.

20. The method of claim 18, wherein said density is at least 1.4 g/cm³.

21. The method of claim 18, wherein said density is at least 1.45 g/cm³.

22. The method of claim 18, wherein said density is at least 1.5 g/cm³.

23. The method of claim 18, wherein said density is at least 1.55 g/cm³.

24. The method of claim 18, wherein said density is at least 1.6 g/cm³.

25. The method of claim 18, wherein said reactive oxidizing species are comprised of oxygen-containing reactive radicals more reactive than diatomic oxygen.

26. The method of claim 25, wherein said reactive oxidizing species are comprised of oxygen-containing reactive radicals and/or ions.

27. The method of claim 26, wherein said oxygen-containing reactive radicals and/or ions are comprised of excited state monoatomic oxygen species.

28. The method of claim 18, wherein said oxidation process is conducted for up to 60 minutes to achieve said density greater than 1.3 g/cm³.

29. The method of claim 19, wherein said oxidation process is conducted for up to 60 minutes to achieve said density of at least 1.35 g/cm³.

30. The method of claim 20, wherein said oxidation process is conducted for up to 60 minutes to achieve said density of at least 1.4 g/cm³.

31. The method of claim 21, wherein said oxidation process is conducted for up to 60 minutes to achieve said density of at least 1.45 g/cm³.

32. The method of claim 22, wherein said oxidation process is conducted for up to 60 minutes to achieve said density of at least 1.5 g/cm³.

33. The method of claim 23, wherein said oxidation process is conducted for up to 60 minutes to achieve said density of at least 1.55 g/cm³.

34. The method of claim 24, wherein said oxidation process is conducted for up to 60 minutes to achieve said density of at least 1.6 g/cm³.

35. The method of claim 18, wherein said reactive oxidizing species are maintained in close proximity to said PAN fiber during the oxidation process by flowing said reactive oxidizing species non-turbulently under a near-laminar flow condition.

36. The method of claim 18, wherein said oxidation process is conducted at a temperature in the range of 120-260° C.

37. The method of claim 18, wherein said oxidation process is conducted at a temperature in the range of 160-260° C.

38. The method of claim 18, wherein said oxidation process is conducted at a temperature in the range of 180-260° C.

39. The method of claim 18, wherein said oxidation process is conducted at a temperature in the range of 120-230° C.

40. The method of claim 18, wherein said oxidation process is conducted at a temperature in the range of 160-230° C.

41. The method of claim 18, wherein said oxidation process is conducted at a temperature in the range of 180-230° C.

42. The method of claim 18, further comprising, after said oxidation process has achieved said density, a surface modification process comprising introducing into said oxidation process at least one surface reactive species that functionalizes the surface of the oxidized PAN fiber.

43. The method of claim 18, wherein the PAN fiber, before oxidation, is composed solely of PAN.

44. The method of claim 18, wherein the PAN fiber, before oxidation, is composed of PAN-containing copolymer.

45. The method of claim 44, wherein said PAN-containing copolymer is comprised of at least 75 mol % acrylonitrile monomer units and up to 25 mol % of non-PAN monomer units, wherein said copolymer units are selected from unsaturated carboxylate and unsaturated amide monomer units.

46. The method of claim 44, wherein said PAN-containing copolymer is comprised of at least 85 mol % acrylonitrile monomer units and up to 15 mol % of non-PAN monomer units, wherein said copolymer units are selected from unsaturated carboxylate and unsaturated amide monomer units.

47. The method of claim 45, wherein said unsaturated carboxylate copolymer units are selected from methyl acrylate, ethyl acrylate, propyl acrylate, butyl acrylate, methylmethacrylate, (2-hydroxyethylacrylate), vinyl acetate, acrylic acid, methacrylic acid, and itaconic acid.

48. The method of claim 45, wherein said unsaturated amide copolymer units are selected from acrylamide, methacrylamide, N-alkyl derivatives thereof, and N,N-dialkyl derivatives thereof.

49. The method of claim 18, wherein said PAN fiber is subjected to said oxidation process for up to 30 minutes.

50. The method of claim 18, wherein said oxidation process is a plasma oxidation process.

51. A method for forming a flame-retarded textile, the method comprising partially oxidizing PAN fibers up to a density of about 1.4 g/cm³, weaving the partially oxidized PAN fibers with fibers of a textile to be flame retarded to form a preform, and further oxidizing said preform until said PAN fibers possess a density greater than the density of the partially oxidized PAN fibers.

52. The method of claim 51, comprising partially oxidizing said PAN fibers up to a density in the range of about 1.3 and up to about 1.4 g/cm³, weaving the partially oxidized PAN fibers with fibers of a textile to be flame retarded to form a preform, and further oxidizing said preform until said PAN fibers possess a density greater than the density of the partially oxidized PAN fibers.

53. The method of claim 51, wherein said textile to be flame retarded is a fabric used in clothing.

54. The method of claim 53, wherein said fabric is selected from the group consisting of cotton, polyester, nylon, silk, wool, rayon, cellulose acetate, spandex, and blends thereof.
